(19) United States
(12) Patent Application Publication
(10) Pub. No.: US 2020/0372424 A1
(43) Pub. Date: Nov. 26, 2020

(54) SYSTEM AND METHOD FOR GENERATING RISK-CONTROL RULES

(71) Applicant: Alibaba Group Holding Limited, George Town (KY)

(72) Inventors: Tianyi Zhang, Hangzhou (CN); Bowen Song, Hangzhou (CN)

(73) Assignee: Alibaba Group Holding Limited, George Town (KY)

(21) Appl. No.: 16/984,653

(22) Filed: Aug. 4, 2020

Related U.S. Application Data
(63) Continuation of application No. PCT/CN2019/073565, filed on Jan. 29, 2019.

(30) Foreign Application Priority Data
Feb. 12, 2018 (CN) 201810144812.1

(51) Int. Cl. G06Q 10/06; G06K 9/62; G06N 7/00

(52) U.S. Cl. CPC G06Q 10/0635; G06N 7/00; G06K 9/6257; G06K 9/6282

(57) ABSTRACT

One embodiment of the present disclosure provides a system and method for generating risk-control rules. During operation, the system can obtain a first data set and a second data set. The first data set can be associated with a first set of events in a first domain. The second data set can be associated with a second set of events in a second domain. The system can combine the first data set and the second data set to generate a sample data set and train a statistical model by applying the sample data set to determine a set of weights. The system can determine a set of conditions based on the set of weights. Next, the system can generate a set of risk-control rules based on the set of conditions. The system can then apply the set of risk-control rules to a current event in the second domain to determine a credibility of the current event.

### RELATED APPLICATION

Under 35 U.S.C. § 120 and § 365(c), this application is a continuation of PCT Application No. PCT/CN2019/073565, entitled “METHOD AND DEVICE FOR GENERATING RISK-CONTROL RULES,” by inventors Tianyi Zhang and Bowen Song, filed 29 Jan. 2019, which claims priority to Chinese Patent Application No. 201810144812.1, filed on 12 Feb. 2018.

### BACKGROUND

### Field

This disclosure is generally related to the field of data processing and machine learning. More specifically, this disclosure is related to a system and method for generating risk-control rules.

### Related Art

The rapid development of computing technologies has allowed the Internet technology to be extended into the financial domain. Various types of online financial services (e.g., third-party payment services, peer-to-peer lending services, crowdfunding services, online-banking services, online-brokerage services, etc.) are currently being provided to customers. Risk-control is important to ensure confidence of customers of online financial services and to prevent financial crimes, e.g., fraud risk, manipulating sensitive details, money laundering, etc.

Many online financial services can include or be coupled to a risk-control system. Before the execution of a transaction (e.g., a transfer, a deposit, a withdrawal, etc.), the online financial service can forward the transaction to the risk-control system, which can identify potential risks associated with the transaction and outputs a risk-control command. For example, if the risk-control system identifies a risk (e.g., a fraud risk or a money-laundering risk) associated with an online-banking transaction, it can output a risk-control command to the online-banking service, prompting the online-banking service to stop the transaction and freeze the accounts involved in the transaction. If the risk-control system determines that there is no risk or the risk level is low, it can output a risk-control command to instruct the online-banking service to execute the transaction as normal.

The operation of the risk-control system can be based on a set of risk-control rules that can be used to distinguish between a credible transaction and a fraud transaction. The accuracy of these risk-control rules can be highly dependent on the size of the financial service and on the amount of historical transaction data including cases that have been reported to be fraud transactions. A newly established financial service may often include small amount of historical transaction data that can be seriously lacking in relevant information or can be erroneous, thereby significantly affecting the accuracy of the risk-control rules and fraud protection capability of the risk-control system.

### SUMMARY

One embodiment of the present disclosure provides a system and method for generating risk-control rules. During operation, the system can obtain a first data set and a second data set. The first data set can be associated with a first set of events in a first domain. The second data set can be associated with a second set of events in a second domain. The system can combine the first data set and the second data set to generate a sample data set and can train a statistical model by applying the sample data set to determine a set of weights. The system can determine a set of conditions based on the set of weights. Next, the system can generate a set of risk-control rules based on the set of conditions. The system can then apply the set of risk-control rules to a current event in the second domain to determine a credibility of the current event.

In a variation on this embodiment, the system can combine the first data set and the second data set to generate the sample data set by identifying data with one or more of: identical dimensions; and identical service logic definition in the first domain and the second domain.

In a variation on this embodiment, during the process of training the statistical model, the system can initialize a classification model with an initial set of weights based on the sample data set; and can adjust the initial set of weights until a classification correction rate associated with the classification model satisfies a pre-defined convergence threshold value to obtain the set of weights.

In a further variation on this embodiment, the system can adjust the initial set of weights by: decreasing a first subset of weights corresponding to a first portion of the sample data set that is misclassified, wherein the first portion of the sample data set is associated with a first domain; and increasing a second subset of weights corresponding to a second portion of the sample data set that is misclassified, wherein the second portion of the sample data set is associated with a second domain.

In a further variation on this embodiment, the system can train the statistical model based on a Transfer Adaptive Boosting (TrAdaBoost) technique. The system can determine the set of conditions by applying a weighted decision tree algorithm.

In a further variation on this embodiment, the first data set and the second data set represent customer relationship management Recency Frequency Monetary (RFM) data used for indicating risk similarity in transaction events.

In a further variation on this embodiment, the customer relationship management RFM data can include one or more of: transaction related parameters; internet risk related parameters; and historical behavior related parameters.

In a further variation on this embodiment, the first domain can represent a well-established financial service with large amount of historical transaction data; and the second domain can represent a new financial service with significantly less transaction data compared to that in the first domain

### BRIEF DESCRIPTION OF THE FIGURES

FIG. 1 illustrates an exemplary system for generating risk-control rules, in accordance with the prior art.

FIG. 2 illustrates an exemplary system for generating risk-control rules, in accordance with an embodiment of the present disclosure.

FIG. 3 illustrates an exemplary example of a weighted decision tree, in accordance with an embodiment of the present disclosure.

FIG. 4A presents a flowchart illustrating a process for generating risk-control rules, in accordance with an embodiment of the present disclosure.

FIG. 4B presents a flowchart illustrating a process for generating risk-control rules, in accordance with an embodiment of the present disclosure.

FIG. 5 illustrates an exemplary computer system that facilitates generation of risk-control rules, in accordance with an embodiment of the present disclosure.

FIG. 6 illustrates an exemplary apparatus that facilitates generation of risk-control rules, in accordance with an embodiment of the present disclosure.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the embodiments described herein are not limited to the embodiments shown, but are to be accorded the widest scope consistent with the principles and features disclosed herein.

Overview

Embodiments described in the present disclosure provide a technical solution to a technical problem of quickly adapting a process of generating risk-control rules in a new financial domain. The new financial domain can represent a newly established financial service in a new country or a new market with small amount of historical transaction data. To compensate for the small amount of transaction data in the new financial domain, the system can create a sample data set by combining historical transaction data from a well-established financial domain and historical transaction data available in the new financial domain. The system can train a classification model by applying the sample data set to determine a set of weights and these weights can be adjusted until the classification model reaches a pre-defined convergence value. The system can then use the adjusted set of weights to determine a set of conditions for generating a set of risk-control rules. The system can use the set of risk-control rules to determine the credibility of a real-time transaction in the new financial domain.

Specifically, the embodiments described in the present disclosure can effectively combine historical transaction data from the well-established financial domain and transaction data from the new financial domain, to quickly generate the risk-control rules for new financial services in the new financial domain. In other words, the system can effectively utilize the historical transaction data of already existing markets in other countries to increase the efficiency of generating the risk-control rules, thereby providing an improved protection against fraud transactions in the new financial domain.

### Risk-Control Rules Generation System

In general, risk level in online financial services can be detected based on a set of risk-control rules. In the existing risk-control systems, risk-control rules can be generated based on a dual-entity pair to determine the credibility of a transaction. In other words, the system may use two entities, i.e., credit card and original delivery address, as a dual-entity pair to determine the credibility of an online financial transaction. Specifically, when the dual-entity pair appears together in an online financial transaction, the system can determine that the transaction is a credible transaction.

For example, a credit card used in online financial transactions may be stolen, and any subsequent online transaction made using the stolen credit card may include at least one different parameter setting, e.g., a delivery address entered while performing the new online transaction may be different from the original delivery address. In other words, there can be a low probability of using the original delivery address after the credit card is stolen. Different types of dual-entity pairs can be used, e.g., card-device credibility, card-Internet Protocol (IP) credibility, account-device credibility, etc.

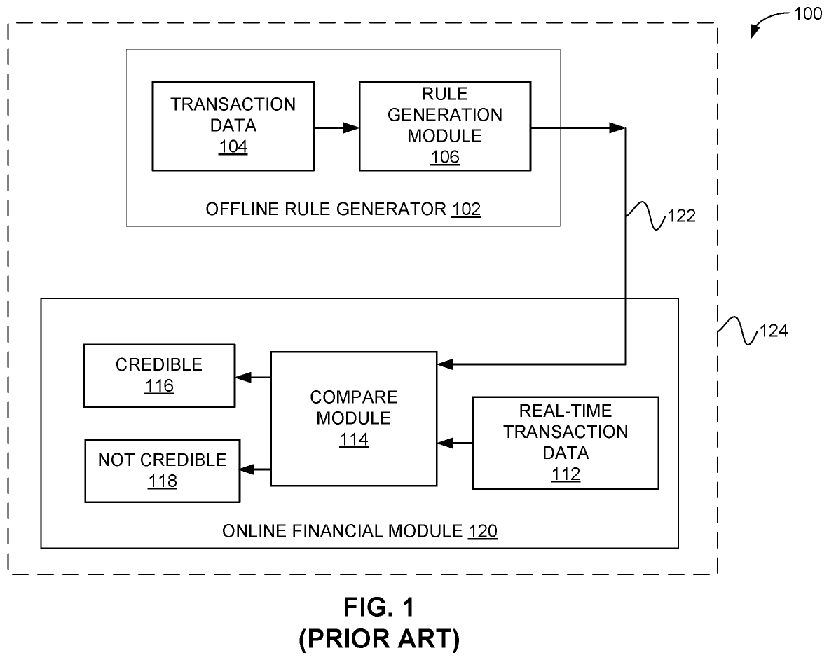

FIG. 1 illustrates an exemplary system for generating risk-control rules, in accordance with the prior art. System 100 can include an offline rule generator 102 and an online financial module 120. In system 100, both offline rule generator 102 and online financial module 120 can be included in a single financial domain 124, e.g., a well-established market with sufficient historical transaction data 104. Offline rule generator 102 can use a rule generation module 106 to generate a set of risk-control rules 122 based on local historical transaction data 104.

In response to generating set of risk-control rules 122, system 100 can determine the credibility of a current transaction event. Specifically, in a real-time transaction scenario, system 100 can use a compare module 114 to determine whether real-time transaction data 112 satisfies set of risk-control rules 122. When a match is identified, system 100 can determine that real-time transaction is credible, otherwise real-time transaction is identified as not credible.

The operation of system 100 is limited to local historical transaction data 104 within just one financial domain. Since the accuracy of set of risk-control rules 122 is highly dependent on the amount of historical transaction data 104, system 100 may generate inaccurate set of risk-control rules 122 in the absence of sufficient historical transaction data 104.

For example, in a new financial domain where financial services are in an initial phase in a new market, may often include small amount of historical transaction data that can be seriously lacking in relevant information or can be erroneous, thereby significantly affecting the accuracy of the risk-control rules. Furthermore, in a new financial service market accumulating historical transaction data can take a long time, thereby resulting in a large delay in generating risk-control rules. Such large delays can make the newly established financial service to provide poor risk-control and significant inconvenience to affected customers. For example, when a fraud transaction event occurs in the newly established financial services, the risk-control system may report the refusal of payment via credit card after a delay of more than three months, thereby impacting the fraud protection capability of system 100 in the new financial domain.

To overcome the aforementioned problems, some embodiments described in the present disclosure can leverage the historical transaction data available in a source domain, e.g., a well-established market, to quickly generate risk-control rules for new financial services in a target domain, e.g., in a new country or a new market. In other words, the system can combine the historical transaction data from the source domain and historical transaction data from the target domain to quickly generate risk-control rules, thereby effectively increasing the efficiency and accuracy associated with generating the risk-control rules, and providing adequate protection against fraud transactions in the new financial domain.

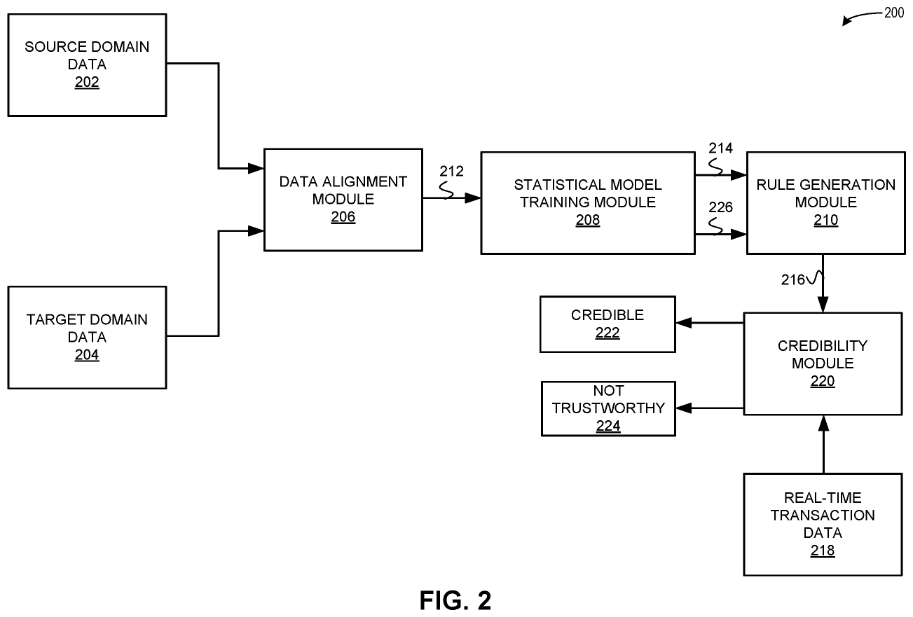

FIG. 2 illustrates an exemplary system for generating risk-control rules, in accordance with an embodiment of the present disclosure. Specifically, FIG. 2 illustrates a system 200 for generating risk-control rules in a new financial domain, i.e., in a financial domain where new financial services are in an initial development phase. Furthermore, the new financial domain may include small amount of transaction data that may not be sufficient to generate a set of risk-control rules in a timely and effective way. To improve the effectiveness of system 200, system can borrow historical transaction data accumulated in a mature market, i.e., represented as source domain data 202. The amount of source domain data 202 can be significantly larger when compared to the amount of target domain data 204.

In a typical marketing domain, customer relationship can be managed by using Recency-Frequency-Monetary (RFM) variable data that quantify a customer's transactional behavior. Recency (R) can refer to when a last transaction was made by a customer in a financial domain; Frequency (F) can refer to a number of transactions made by a customer in a given period of time; Monetary (M) can refer to the amount spent by a customer. Further, RFM variable data can correspond to transaction specific variables, risk related variables, and user behavior related variables. The RFM variable data can also include other types of RFM variables. For example, in a credit-card based transaction, different types of variable data can be available, i.e., credible behavior variable data type, internet variable data type, and risk network variable data type. Credible behavior variable data type can include information about real-time transaction, card-related history, account-related history, medium-related history, environment-related history, etc. Internet variable data type can include information about case report rate, risk control rejection rate, 3D rejection rate, ratio of new users, credibility rate, etc. Risk network variable data type can include information about whether an associated group has cases/case rate, whether an associated group is credible group/credibility rate, etc.

System 200 can leverage RFM values in source domain data 202 and target domain data 204 to generate a sample data set. In one embodiment, system 200 can align source domain data 202 and target domain data 204 to include data with similar data structures. Specifically, a data alignment module 206 can combine source domain data 202 and target domain data 204 based on one or more data fields. For example, transaction data can include a set of variable fields with associated variable dimension and/or variable service logic definition.

More specifically, data alignment module 206 can combine source domain data 202 and target domain data 204 into a sample data set 212 based on RFM values that can describe transactional events that are similar in both domains, e.g., RFM values that can describe risk similarity of transaction events. Transaction data in source domain data 202 and target domain data 204 with similar variable dimension fields and/or similar service logic definition according to RFM values can be identified and included in sample data set 212.

System 200 can use sample data set 212 as input to a statistical model training module 208 to train a classification model. Specifically, statistical model training module 208 can use a Transfer Adaptive Boosting (TrAdaBoost) algorithm to determine a set of weights for sample data set 212 and to improve the classification accuracy of the classification model. Statistical model training module 208 can first train the classification model based on a labeled sample data set. The classification accuracy of the resulting classification model can be determined by applying the classification model to target domain data without labels. Classification accuracy can be used as a measure to determine whether source domain data 202 and target domain data 204 are misclassified.

During the process of training the classification model, statistical model training module 208 can initialize the classification model based on sample data set 212 to generate an initial set of weights corresponding to sample data set 212. Specifically, statistical model training module 208 can identify misclassified source domain data 202, i.e., a portion of source domain data 202 that can be different from target domain data 204 can be grouped under incorrectly classified data or misclassified data. The initial subset of weights associated with misclassified source domain data can be decreased to reduce the likelihood of occurrence of misclassified data in the future. On the other hand, initial subset of weights corresponding to misclassified target domain data, i.e., target domain data that can be difficult to classify, can be increased to reduce a probability of misclassification of target domain data.

Statistical model training module 208 can optimize the classification model in a number of iterations with respect to sample data set 212. Specifically, in each iteration step, the classification model can determine a subset of source domain data in sample data set 212 that are misclassified and can decrease a corresponding subset of weights. Furthermore, the classification model can determine a subset of target domain data in sample data set 212 that are misclassified and increase a corresponding subset of weights. The classification model may continue to decrease and increase a subset of weights associated with source domain data and target domain data, respectively, until a classification correction rate of the classification model satisfies a pre-defined convergence threshold value. When a classification correction rate satisfies the pre-defined convergence threshold value, the determined set of weights can represent an optimized set of weights 214 corresponding to the samples in sample data set 212.

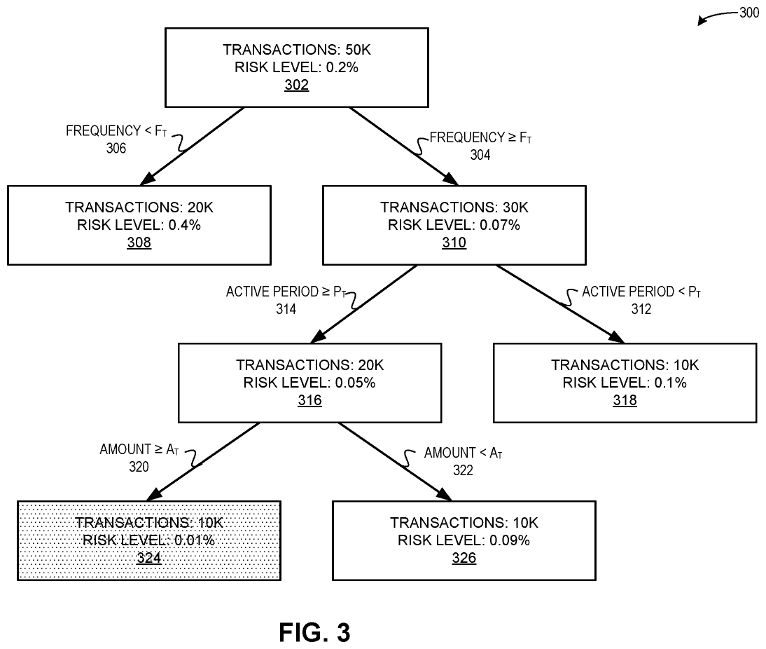

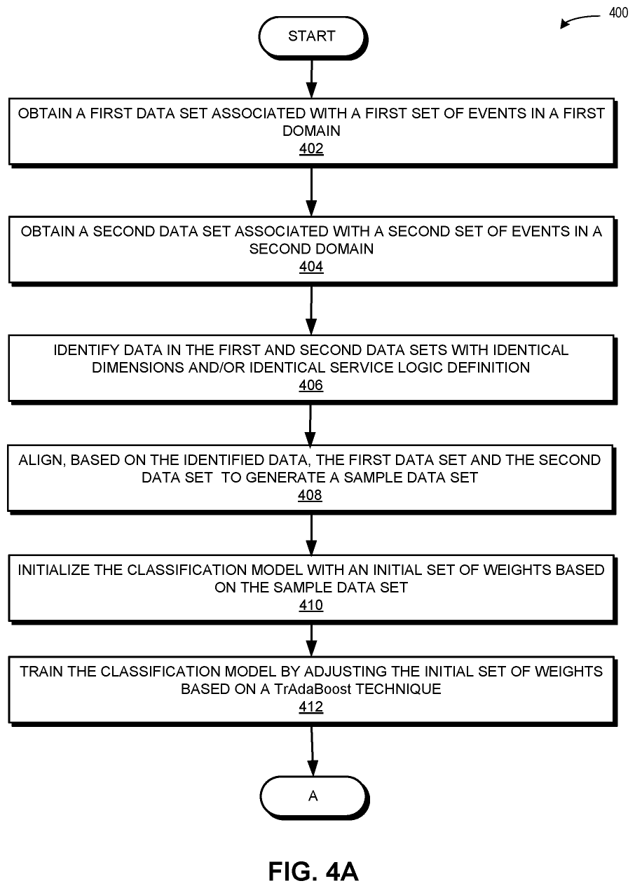

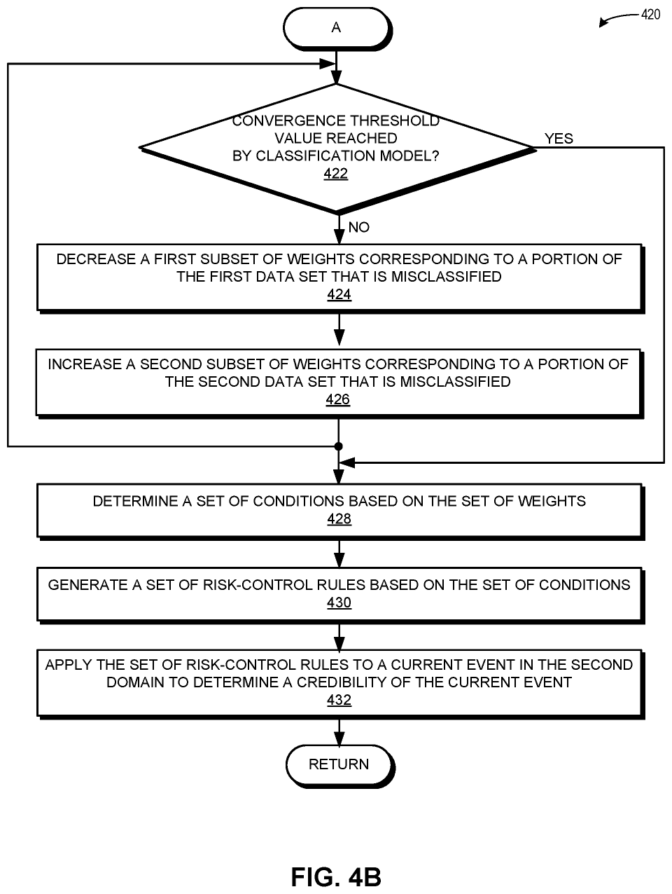

A rule generation module 210 can use optimized set of weights 214 and corresponding samples in sample data set 226 to generate a set of risk-control rules 216. A credibility module 220 can use set of risk-control rules 216 to determine whether a current transaction event associated with real-time transaction data 218 in the target domain is a credible transaction 222 or a fraud transaction 224. In the following paragraphs, rule generation module 210 is described in further detail in relation to FIGS. 3 and 4.

FIG. 3 illustrates an exemplary example of a weighted decision tree, in accordance with an embodiment of the present disclosure. In example 300 shown in FIG. 3, a credit-card based transaction is used as an example to illustrate the process for determining a set of characteristic parameter values and the risk-control rules using a weighted decision tree algorithm. Specifically, based on the set of weights determined by the classification model, the system can use the samples from the source domain for learning risk-control rules in the target domain.

The system can preset a transaction risk level for a dual-entity credibility pair as less than one risk transaction in 10,000 transactions, i.e., the occurrence of a risk transaction in 10,000 transactions can be set to less than one. The system can use the weighted decision tree algorithm to build a weighted decision tree with number of layers, and each layer can be identified by a branch parameter and a branch conditional threshold value corresponding to relevant RFM variables. Furthermore, the weighted decision tree can be adapted based on the historical transaction data available.

In example 300, the weighted decision tree can include three different layers. For example, the weighted decision tree can start with a parent node 302 that can represent a sample data set of 50,000 credit-card transactions which can include the source domain data and the target domain data. The weighted decision tree algorithm can determine, based on the total number of transactions and the optimized set of weights output by a classification model, the first layer branch parameter as transaction frequency and can determine a first layer branch threshold value, F_{T}, for the transaction frequency, e.g., F_{T}=3. The transaction frequency can refer to the number of transactions a customer performs in a given time period.

The first layer branch parameter and threshold value can be used as an attribute for splitting the sample data set of 50,000 transactions into two groups. Specifically, when transaction frequency is less than F_{T} (condition 306), parent node 302 can be branched into sub-node 308 with 20,000 transactions and a risk level of 0.4%. When transaction frequency ≤F_{T} (condition 304), parent node 302 can be branched into sub-node 310 with 30,000 transactions and a risk level of 0.07%.

Next, the weighted decision tree algorithm may select a sub-node with the least risk level, e.g., sub-node 310 can be selected, and based on the number of transactions in sub-node 310 and the associated set of weights, a second layer branch parameter can be selected. For example, the second layer branch layer parameter can be an active period of an account and a threshold value P_{T} can be set to 60 days. When the active period of an account ≥P_{T} (condition 314) then sub-node 310 can branch to node 316, and when the active period of the account is less than P_{T} (condition 312), sub-node 310 can branch to node 318. Since the risk level calculated for node 316 is less than that in node 318, the weighted decision tree algorithm can select node 318 for performing further analysis for the group of transactions in node 316.

The weighted decision tree algorithm can split node 316 based on a third layer branch parameter value which can be determined based on the transactions in node 316 and a set of weights corresponding to the transactions. For example, an amount associated with each transaction can be selected as the third layer branch parameter and a threshold value A_{T} can be set to 400. When the transaction amount ≥A_{T}, node (condition 316) can branch to node 324, and when the transaction amount <A_{T} (condition 322), node 316 can branch to node 326. Since the risk level calculated for node 324 satisfies the desired risk level, e.g., the desired risk level can be 0.01% in 10,000 transactions, the system can identify the different branch layer parameters associated with 304, 314, and 320, as the characteristic parameter values for determining a set of risk-control conditions. The system can use the set of risk-control conditions for generating the set of risk-control rules.

For example, the risk-control conditions can be associated with a dual-entity credibility pair, i.e., {credit card, original delivery address}. For example, the risk-control conditions can include: number of times dual-entity credibility pair can exceed a threshold value F_{T}, number of times the transaction amount can exceed a threshold value A_{T}, and number of times no risk has been reported after P_{T} days.

In example 300 shown in FIG. 3, the characteristic parameter values (F_{T}, A_{T}, P_{T}) can correspond to (3, 400, 60). Based on these characteristic parameter values the risk-control rules can be determined when “number of times dual-entity credibility pair exceeds a threshold value 3, the transaction amount exceeds a threshold value 400, and no risk has been reported after 60 days.”

By applying the weighted decision tree algorithm and the classification model to the sample data set that includes both the source domain data and the target domain data, the system can quickly determine the set of characteristic parameter values. In addition, the accuracy of the characteristic parameter values can be effectively increased by including the source domain data which can improve the accuracy of the risk-control rules in the target domain, thereby effectively increasing the efficiency of the process for generating the risk-control rules.

FIGS. 4A and 4B present a flowchart illustrating a process for generating risk-control rules, in accordance with an embodiment of the present disclosure. Referring to FIG. 4A, during operation, a system may obtain a first data set associated with a first set of events in a first domain, e.g., the first domain can represent a mature market with sufficient amount of transaction history data (operation 402). In addition to the first data set, the system can obtain a second data set associated with a second set of events in a second domain, e.g., the second domain can represent a newly established market with small amount of transaction data.

The system can then identify data in the first data set and the second data set with identical dimensions and/or identical service logic definition (operation 406). Next, the system can align based on the identified data, the first data set and the second data set to generate a sample data set (operation 408). The system can then train a classification model by: initializing a classification model with an initial set of weights based on the aligned first data set and the second data set (operation 410); and adjusting the initial set of weights based on a TrAdaBoost algorithm (operation 412), the operation continues at label A.

Referring to FIG. 4B, the system can optimize the classification model by determining whether a classification correction rate of the classification model has reached a convergence threshold value (operation 422). When the classification correction rate does not satisfy the convergence threshold value, the system can decrease a first subset of weights corresponding to a portion of the first data set that is misclassified (operation 424). The system can then increase a second subset of weights corresponding to a portion of the second data set that is misclassified (operation 426). After adjusting the first subset of weights and the second subset of weights the system can continue to verify whether the classification correction rate of the classification model has reached the convergence threshold value (operation 422). The classification model is said to be optimized when the convergence threshold value is satisfied.

In response to the system determining that the classification correction rate of the classification model has reached a convergence threshold, the system can output an optimized set of weights. The system can determine a set of conditions based on the optimized set of weights (operation 428) and can generate a set of risk-control rules based on the set of conditions (operation 430). Next, the system can apply the set of risk-control rules to a current event in the second domain to determine a credibility of the current event (operation 432) and the operation returns.

### Exemplary Computer System and Apparatus

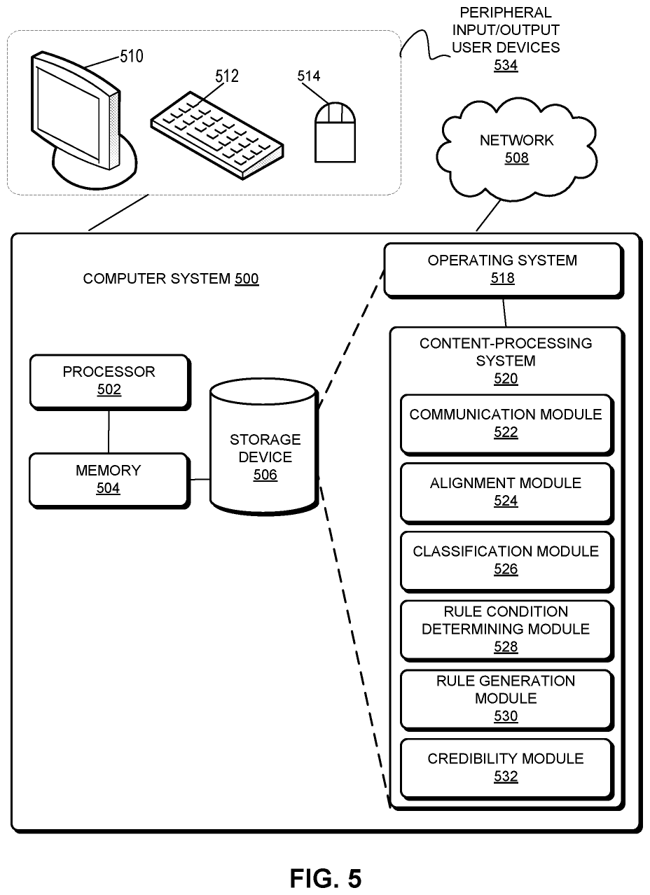

FIG. 5 illustrates an exemplary computer system that facilitates the generation of risk-control rules, in accordance with an embodiment of the present disclosure. Computer system 500 can include a processor 502, a memory 504, and a storage device 506. Computer system 500 can be coupled to a plurality of peripheral input/output devices 534, e.g., a display device 510, a keyboard 512, and a pointing device 514, and can also be coupled via one or more network interfaces to network 508. Storage device 506 can store an operating system 518 and a content processing system 520.

In one embodiment, content processing system 520 can include instructions, which when executed by processor 502 can cause computer system 500 to perform methods and/or processes described in this disclosure. Content processing system 520 can include a communication module 522 to obtain a first data set from a first domain and a second data set from a second domain. Content processing system 520 can further include instructions implementing an alignment module 524 for aligning the first data set and the second data set based on identical dimensions and/or identical service logic definition. Content processing system 520 can include a classification module 526 for training a classification model to identify misclassified data in the first and second data set, and for continuously adjusting a set of weights associated with the first and second data set until a convergence threshold value for the classification model is reached. Content processing system 520 can further include a rule condition determining module 528 for determining a set of conditions based on a final set of weights output by classification module 526 corresponding to the first and second data set. Content processing system 520 can include a rule generation module 530 for generating a set of risk-control rules based on the set of conditions. Content processing system 520 can further include a credibility module 532 for determining a credibility of a current transaction event in the second domain based on the set of risk-control rules.

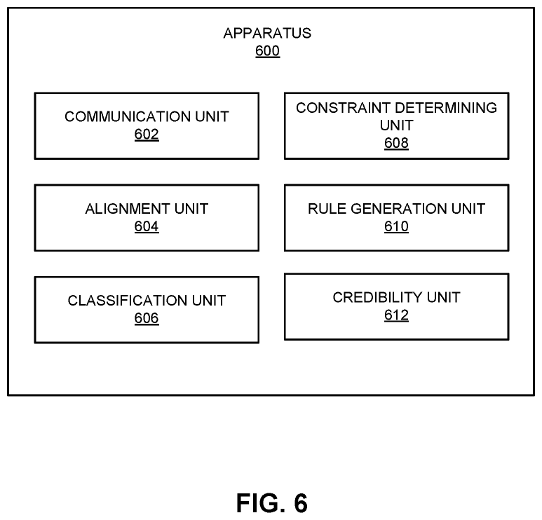

FIG. 6 illustrates an exemplary apparatus that facilitates a data compression scheme, according to one embodiment of the present disclosure. Apparatus 600 can include a plurality of units or apparatuses that may communicate with one another via a wired, wireless, quantum light, or electrical communication channel. Apparatus 600 may be realized using one or more integrated circuits, and may include fewer or more units or apparatuses than those shown in FIG. 6. Further, apparatus 600 may be integrated in a computer system, or realized as a separate device that is capable of communicating with other computer systems and/or devices. Specifically, apparatus 600 can include units 602-614, which perform functions or operations similar to modules 522-532 of computer system 500 in FIG. 5. Apparatus 500 can include: a communication unit 602, an alignment unit 604, a classification unit 606, a rule condition determining unit 608, a rule generation unit 610, and a credibility unit 612.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

Furthermore, the methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art. Additionally, the above disclosure is not intended to limit the present disclosure. The scope of the present disclosure is defined by the appended claims.

What is claimed is:

1. A computer-implemented method, comprising:
obtaining a first data set and a second data set, wherein the first data set is associated with a first set of events in a first domain, and wherein the second data set is associated with a second set of events in a second domain;
combining the first data set and the second data set to generate a sample data set;
training a statistical model by applying the sample data set to determine a set of weights;
determining a set of characteristic parameter values and a set of conditions based on the set of weights;
generating a set of risk-control rules based on the set of conditions and the set of characteristic parameter values; and
applying the set of risk-control rules to a current event in the second domain to determine a credibility of the current event.

2. The method of claim 1, wherein combining the first data set and the second data set to generate the sample data set comprises:
identifying data with one or more of:
identical dimensions; and
identical service logic definition in the first domain and the second domain.

3. The method of claim 1, wherein training the statistical model by applying the sample data set to determine the set of weights comprises:
initializing a classification model with an initial set of weights based on the sample data set; and
adjusting the initial set of weights until a classification correction rate associated with the classification model satisfies a pre-defined convergence threshold value to obtain the set of weights.

4. The method of claim 3, wherein adjusting the initial set of weights further comprises:
decreasing a first subset of weights corresponding to a first portion of the sample data set that is misclassified, wherein the first portion of the sample data set is associated with a first domain; and
increasing a second subset of weights corresponding to a second portion of the sample data set that is misclassified, wherein the second portion of the sample data set is associated with a second domain.

5. The method of claim 1, wherein training the statistical model by applying the sample data set to determine the set of weights is based on a Transfer Adaptive Boosting (TrAdaBoost) technique; and
wherein the set of conditions is determined by applying a weighted decision tree algorithm.

6. The method of claim 1, wherein the first data set and the second data set include customer relationship management Recency Frequency Monetary (RFM) data used for indicating risk similarity in transaction events.

7. The method of claim 6, wherein the customer relationship management RFM data includes one or more of:
transaction related parameters;
internet risk related parameters; and
historical behavior related parameters.

8. The method of claim 1, wherein the first domain represents a well-established financial service with large amount of historical transaction data; and
wherein the second domain represents a new financial service with significantly less transaction data compared to that in the first domain.

9. A computer system, comprising:
a processor; and
a storage device coupled to the processor and storing instructions which when executed by the processor cause the processor to perform a method, the method comprising
obtaining a first data set and a second data set, wherein the first data set is associated with a first set of events in a first domain, and wherein the second data set is associated with a second set of events in a second domain;
combining the first data set and the second data set to generate a sample data set;
training a statistical model by applying the sample data set to determine a set of weights;
determining a set of characteristic parameter values and a set of conditions based on the set of weights;
generating a set of risk-control rules based on the set of conditions and the set of characteristic parameter values; and
applying the set of risk-control rules to a current event in the second domain to determine a credibility of the current event.

10. The computer system of claim 9, wherein combining the first data set and the second data set to generate the sample data set comprises:
identifying data with one or more of:
identical dimensions; and
identical service logic definition in the first domain and the second domain.

11. The computer system of claim 9, wherein training the statistical model by applying the sample data set to determine the set of weights comprises:
initializing a classification model with an initial set of weights based on the sample data set; and
adjusting the initial set of weights until a classification correction rate associated with the classification model satisfies a pre-defined convergence threshold value to obtain the set of weights.

12. The computer system of claim 11, wherein adjusting the initial set of weights further comprises:
decreasing a first subset of weights corresponding to a first portion of the sample data set that is misclassified, wherein the first portion of the sample data set is associated with a first domain; and
increasing a second subset of weights corresponding to a second portion of the sample data set that is misclassified, wherein the second portion of the sample data set is associated with a second domain.

13. The computer system of claim 9, wherein training the statistical model by applying the sample data set to determine the set of weights is based on a Transfer Adaptive Boosting (TrAdaBoost) technique; and
wherein the set of conditions is determined by applying a weighted decision tree algorithm.

14. The computer system of claim 9, wherein the first data set and the second data set include customer relationship management Recency Frequency Monetary (RFM) data used for indicating risk similarity in transaction events.

15. The computer system of claim 14, wherein the customer relationship management RFM data includes one or more of:
transaction related parameters;
internet risk related parameters; and
historical behavior related parameters.

16. The computer system of claim 9, wherein the first domain represents a well-established financial service with large amount of historical transaction data; and
wherein the second domain represents a new financial service with significantly less transaction data compared to that in the first domain.

17. A non-transitory computer-readable storage medium storing instructions that when executed by a computer cause the computer to perform a method, the method comprising:
obtaining a first data set and a second data set, wherein the first data set is associated with a first set of events in a first domain, and wherein the second data set is associated with a second set of events in a second domain;
combining the first data set and the second data set to generate a sample data set;
training a statistical model by applying the sample data set to determine a set of weights;
determining a set of characteristic parameter values and a set of conditions based on the set of weights;
generating a set of risk-control rules based on the set of conditions and the set of characteristic parameter values; and
applying the set of risk-control rules to a current event in the second domain to determine a credibility of the current event.

18. The non-transitory computer-readable storage medium of claim 17, wherein combining the first data set and the second data set to generate the sample data set comprises:
identifying data with one or more of:
identical dimensions; and
identical service logic definition in the first domain and the second domain.

19. The non-transitory computer-readable storage medium of claim 17, wherein training the statistical model by applying the sample data set to determine the set of weights comprises:
initializing a classification model with an initial set of weights based on the sample data set; and
adjusting the initial set of weights until a classification correction rate associated with the classification model satisfies a pre-defined convergence threshold value to obtain the set of weights.

20. The non-transitory computer-readable storage medium of claim 19, wherein adjusting the initial set of weights further comprises:
decreasing a first subset of weights corresponding to a first portion of the sample data set that is misclassified, wherein the first portion of the sample data set is associated with a first domain; and
increasing a second subset of weights corresponding to a second portion of the sample data set that is misclassified, wherein the second portion of the sample data set is associated with a second domain.
